(19) United States
(12) Patent Application Publication
(10) Pub. No.: US 2012/0018498 A1
(43) Pub. Date: Jan. 26, 2012

(54) PRE-SOLDER METHOD AND REWORK METHOD FOR MULTI-ROW QFN CHIP

(75) Inventors: Xin Zhong, Guangdong (CN); Chih-Ming Chiang, Taiwan (CN); Chih-Tai Hsu, Taiwan (CN)

(73) Assignee: MEDIATEK (SHENZHEN) INC., Shenzhen (CN)

(21) Appl. No.: 12/997,032

(22) PCT Filed: Jul. 20, 2010
(86) PCT No.: PCT/CN10/75285

§ 371 Date: Dec. 9, 2010

(51) Int. Cl. B23K 31/02; B23K 1/20

(52) U.S. Cl. 228/180.22; 228/256; 228/205; 228/223

(57) ABSTRACT

A pre-solder method for a multi-row quad flat no-lead (QFN) packaged chip is provided. Solder paste is applied on at least one pad of the multi-row QFN packaged chip. The multi-row QFN packaged chip is heated, such that the solder paste on the at least one pad of the multi-row QFN packaged chip becomes solid solder before the multi-row QFN packaged chip is mounted on a substrate.

### FIELD OF INVENTION

The present invention is related to a rework method for a multi-row quad flat no-lead (QFN) packaged chip, and more particularly to a pre-solder method of a multi-row QFN packaged chip.

### BACKGROUND OF THE INVENTION

A quad flat package (QFP) can be divided into different types, such as an I-type (QFI), J-type (QFJ) and non-lead-type (QFN) package, according to the shape of the lead of leadframes therein. Since the QFN package structure has relatively shorter signal traces and a faster speed for signal transmissions, it has become one popular package structure choice for package structures suitable for high-frequency (for example, radio frequency bandwidth) transmission chip packages.

Nowadays, multi-row quad flat no-lead (QFN) package technology is provided as a multi-row and fine pitch package with enhanced thermal/electrical performance. Furthermore, a multi-row QFN package is a cost-effective packaging solution because a package substrate is not necessary to it and it adapts to simpler packaging process. FIG. 1 shows a multi-row QFN package structure 100. The multi-row QFN package structure 100 comprises a leadframe 110, a die 120, a molding compound 130, a plurality of wires 140 and a plurality of pads 150. The die 120 is disposed in a central portion of the leadframe 110. Furthermore, the die 120 is electrically connected to the pads 150 via the wires 140.

Because the multi-row QFN package has multi-row pads, it is difficult to demount a multi-row QFN chip from a printed circuit board (PCB) and then mount the multi-row QFN chip back or mount another multi-row QFN chip on the PCB in order for rework. FIG. 2 shows a multi-row QFN chip 200 which is to be soldered on a PCB in a rework process, wherein each of the pads 150 and the leadframe 110 of the multi-row QFN chip 200 are printed with a solder paste 210 prior to mounting of the multi-row QFN chip 200 to the PCB. During the rework process, the multi-row QFN chip 200 must be accurately placed on the PCB, i.e. a high placement precision is needed for the multi-row QFN chip 200. Otherwise, because the shape of the solder paste 210 is variable, rough placement or shaking of the multi-row QFN chip 200 will cause various defects, such as pin-short, solder-lack, offset and so on; thus, limiting rework yields.

Therefore, a rework method is desired to improve rework yields for a multi-row QFN chip.

### SUMMARY OF THE INVENTION

Pre-solder methods and rework methods for a multi-row quad flat no-lead (QFN) packaged chip are provided. An embodiment of a pre-solder method for a multi-row QFN packaged chip is provided. Solder paste is applied on at least one pad of the multi-row QFN packaged chip. The multi-row QFN packaged chip is heated, such that the solder paste on the at least one pad of the multi-row QFN packaged chip is heated and cools to become solid solder before the multi-row QFN packaged chip is mounted on a substrate.

Furthermore, an embodiment of a rework method for mounting a multi-row quad flat no-lead (QFN) packaged chip on a substrate is provided. A pre-soldered multi-row QFN packaged chip is prepared by applying solder paste on at least one pad of the multi-row QFN packaged chip which is to be mounted on the substrate and heating the applied solder paste on the multi-row QFN packaged chip. The pre-soldered multi-row QFN packaged chip is placed on the substrate, such that the at least one pad of the pre-soldered multi-row QFN packaged chip contacts at least one pad of the substrate via the heated solder paste on the pre-soldered multi-row QFN packaged chip. The placed pre-soldered multi-row QFN packaged chip is heated to mount the placed pre-soldered multi-row QFN packaged chip on the substrate.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows a multi-row QFN package structure;

FIG. 2 shows a multi-row QFN chip which is to be soldered on a PCB in a rework process;

FIG. 3 shows a pre-solder method according to an embodiment of the invention;

FIG. 4A shows a carrier according to an embodiment of the invention;

FIG. 4B shows a portion of a stencil corresponding to a multi-row QFN packaged chip;

FIG. 5 shows a pre-soldered multi-row QFN packaged chip which is to be mounted on a PCB according to the pre-solder method of the invention;

FIG. 6 shows a pre-solder method according to an embodiment of the invention; and

FIG. 7 shows a rework method for mounting a multi-row QFN packaged chip on a printed circuit board according to an embodiment of the invention.

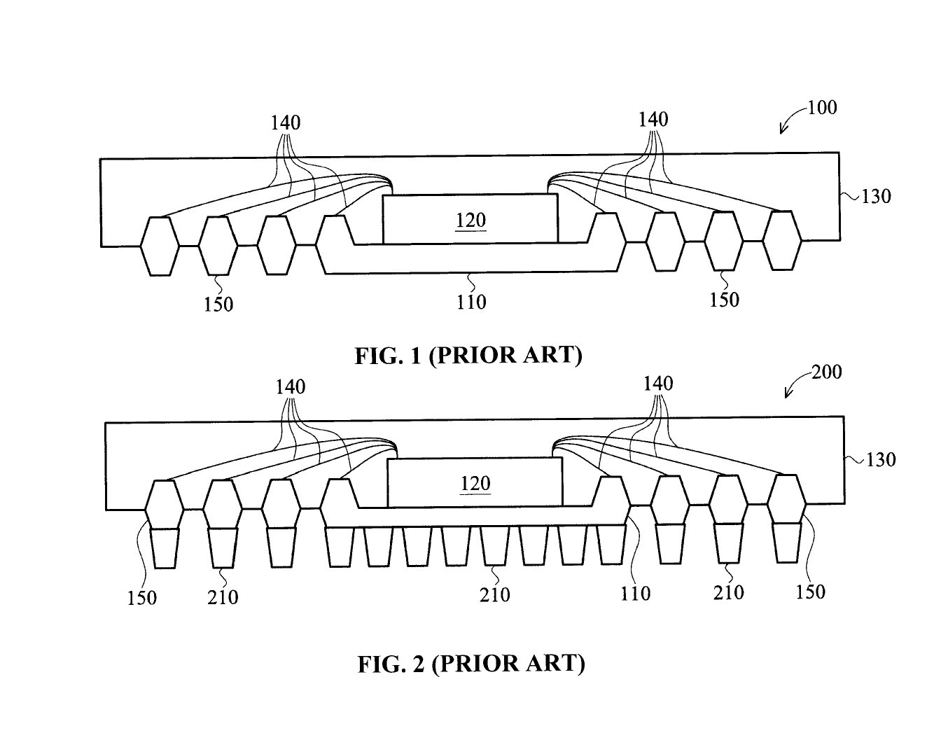

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

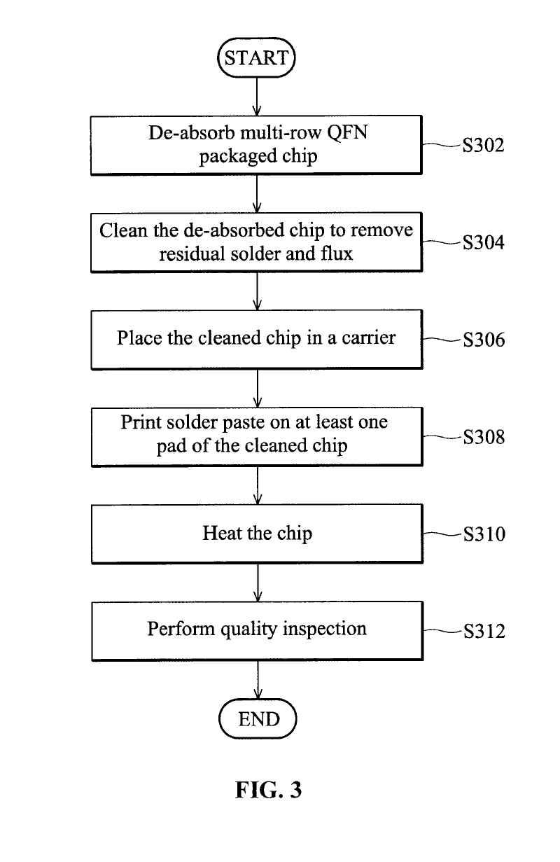

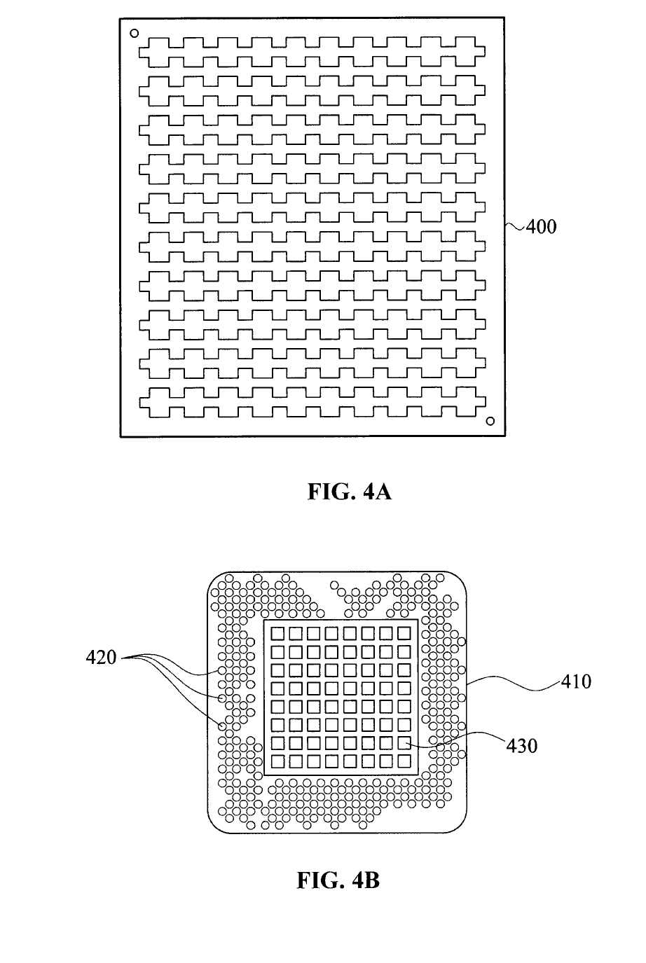

FIG. 3 shows a pre-solder method for one or more multi-row QFN packaged chips according to an embodiment of the invention. First, optionally, in step S302, the chips can be placed at a predetermined temperature (e.g. any temperature between 100-150° C.) over a predetermined time period (e.g. any time period between 1-8 hrs) for de-absorbing the chips. De-absorbing is to take the moisture out of the chips. Next, optionally, in step S304, the chips can be cleaned to remove residue, such as residual solder and/or flux on at least one pad of the chips. Next, the chips can be placed in a carrier (step S306), and then solder paste can be applied, such as printed, on the at least one pad of the chips via stencil by a screen printer (step S308). Referring to FIG. 4A and FIG. 4B, FIG. 4A shows a carrier 400 according to an embodiment of the invention, and FIG. 4B shows a portion of a stencil corresponding to a multi-row QFN packaged chip. In FIG. 4B, the stencil 410 is used to apply, such as print, the solder paste for a chip, wherein a plurality of openings 420 are used to apply the solder paste on the pads of the chip, and the openings 430 are used to apply the solder paste on the die pad, such as exposed pad (e-pad for a QFN package), of the chip.

Referring back to FIG. 3, after the solder paste is applied, such as printed, on the chips, the chips, and optionally the carrier, can be heated in a reflow oven at a predetermined temperature (step S310). The chips are heated to make the solder paste on the chips melted. Then the solder can cool and form a solid solder, i.e. the solder paste is transformed into a solid state. The solid solder can be in a ball shape. Next, optionally, quality inspection is performed, including checking if any solder-short/pad-short happens (step S312). Thus, a pre-soldered multi-row QFN packaged chip is obtained and the pre-soldered multi-row QFN packaged chip may be mounted on pads of a substrate, such as a printed circuit board to repair/rework the printed circuit board.

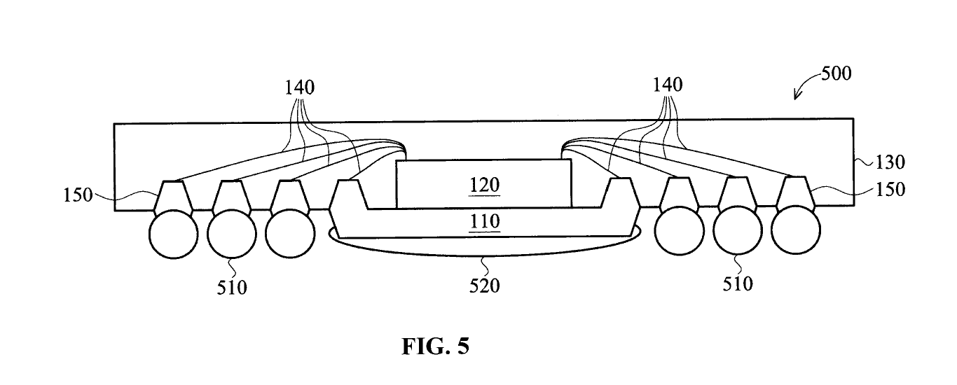

FIG. 5 shows a pre-soldered multi-row QFN chip 500 which is to be mounted on a substrate, such as a PCB according to the pre-solder method of the invention. Compared with the multi-row QFN chip 200 of FIG. 2, the solid solders 510 of the pre-soldered multi-row QFN chip 500 are in a solid state; thus the shapes of the solid solders 510 may not change when the solid solders 510 are touched or the pre-soldered multi-row QFN chip 500 is shifted. Therefore, even when rough placement or shaking happens, rework yield is not hindered when mounting the pre-soldered multi-row QFN chip 500 on a substrate, such as a printed circuit board to repair/rework the printed circuit board. Furthermore, a different shaped solid solder 520 can be formed on the leadframe 110 of the pre-soldered multi-row QFN chip 500 due to surface tension.

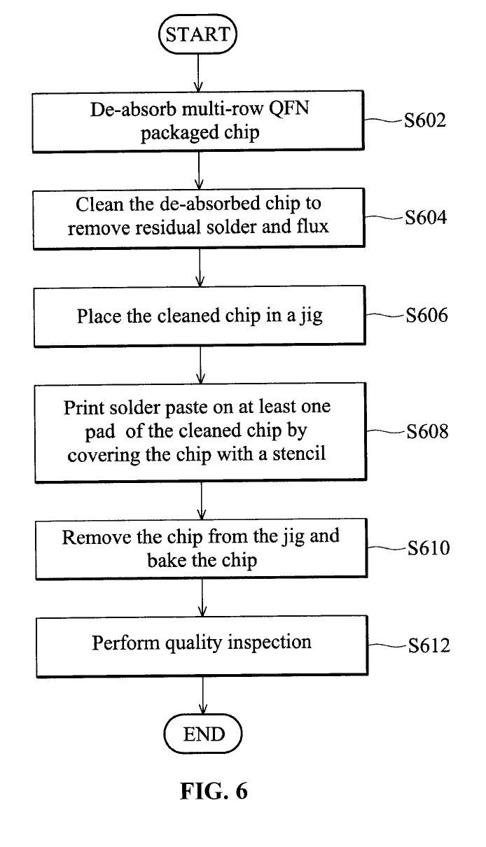

FIG. 6 shows a pre-solder method for a multi-row QFN packaged chip according to an embodiment of the invention. First, optionally, in step S602, the chip can be placed at a predetermined temperature (e.g. any temperature between 100-150° C.) over a predetermined time period (e.g. any time period between 1-8 hrs) for de-absorbing the chips. Next, optionally, in step S604, the chip can be cleaned to remove residue, such as residual solder and/or flux on at least one pad of the chip. Next, the chip can be placed in a jig (step S606), and then solder paste can be applied, such as printed, on the at least one pad of the chip by covering the chip with a stencil (step S608). After the solder paste is applied, such as printed, on the chip, the chip can be removed from the jig and baked by a hot air gun (step S610). The chip is baked to make the solder paste of the at least one pad of the chip melted. Then the solder can cool and form a solid solder, i.e. the solder paste is transformed into solid state, as shown in FIG. 5. The solid solder can be in a ball shape. Next, optionally, quality inspection is performed, including checking if any solder-short/pad-short happens (step S612). Thus, a pre-soldered multi-row QFN packaged chip is obtained and the pre-soldered multi-row QFN packaged chip may be mounted on pads of a substrate, such as a printed circuit board to repair/rework the printed circuit board. In the embodiment, no screen printer and no reflow oven are needed for the multi-row QFN packaged chip.

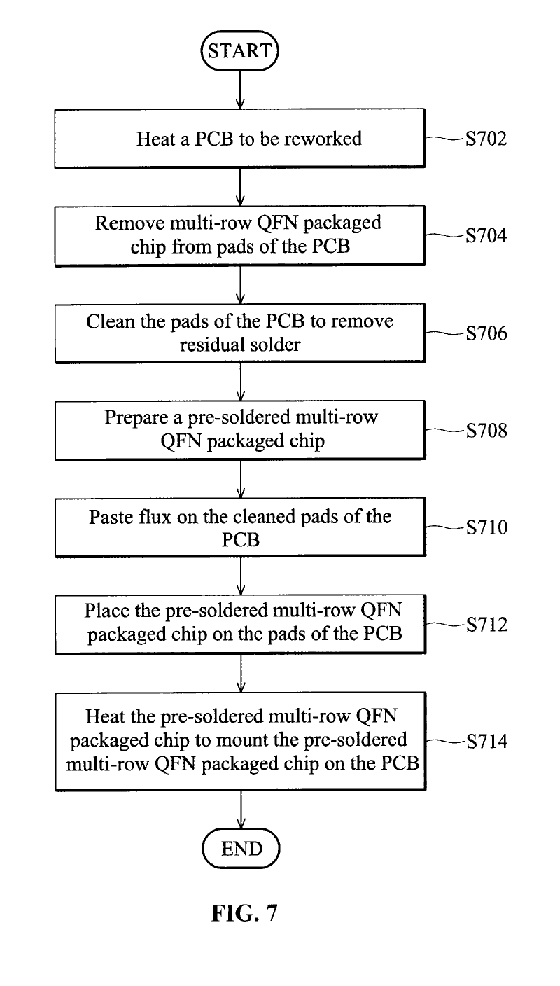

FIG. 7 shows a rework method for mounting a multi-row QFN packaged chip on a substrate, such as a printed circuit board according to an embodiment of the invention. The rework method can be applied in many situations. For example, originally a multi-row QFN packaged chip may not be soldered well, and needs to be removed and soldered back on the substrate, such as PCB. In another example, the multi-row QFN packaged chip originally soldered on the substrate may be found broken, then the broken one should be removed and replaced with another multi-row QFN packaged chip. First, in step S702, a PCB to be reworked can be heated such that temperature, such as the temperature of the bottom of a multi-row QFN packaged chip on the PCB reaches a predetermined temperature (e.g. 200° C.-260° C.), so that the multi-row QFN packaged chip can be removed and replaced with a pre-soldered multi-row QFN packaged chip. Next, in step S704, flux, which may help lowering melting point of the solder, can be pasted on the multi-row QFN packaged chip and then the multi-row QFN packaged chip can be heated. The multi-row QFN packaged chip can be removed from the pads of the PCB with tool such as tweezers when the solder between the pads of the multi-row QFN packaged chip and the pads of the PCB is melted. Next, optionally, in step S706, the pads of the PCB can be cleaned to remove residue, such as residual solder of the removed multi-row QFN packaged chip with tool such as a desoldering wire. Next, in step S708, the pre-soldered multi-row QFN packaged chip can be prepared according to the pre-solder method described in FIG. 3 or FIG. 6. Specifically, the pre-soldered multi-row QFN packaged chip can be obtained by applying solder paste on at least one pad of the multi-row QFN packaged chip which is to be mounted on the PCB and melting/heating the applied solder paste of the multi-row QFN packaged chip. Then the solder on at least one pad of the pre-soldered multi-row QFN packaged chip can cool and become solid solder, as shown in FIG. 5. The solid solder can be in a ball shape. Next, in step S710, flux can be pasted on the pads of the PCB. Next, in step S712, the pre-soldered multi-row QFN packaged chip can be placed on the pads of the PCB, such that the at least one pad of the pre-soldered multi-row QFN packaged chip may correctly contact at least one pad of the PCB via the solid solder of the pre-soldered multi-row QFN packaged chip. Next, in step S714, the pre-soldered multi-row QFN packaged chip placed on the PCB can be heated by tool such as a hot air gun, so as to mount the pre-soldered multi-row QFN packaged chip on the PCB.

It should be noted that the orders of steps of the embodiments above are illustrative only and not meant to be limitations. The steps could be performed in different order or omitted without departing from the spirit of the invention. Compared to traditional rework methods, the embodiments of the invention may improve rework yield by applying solder paste on at least one pad of a multi-row QFN packaged chip, heating/melting the solder paste. Then the solder on at least one pad of a multi-row QFN packaged chip will cool and form a solid solder on the pad before mounting the multi-row QFN packaged chip on a substrate, such as a PCB. The solid solder can be in a ball shape. Thus, solder defect is decreased for the pre-soldered multi-row QFN packaged chip, such as pad-short defect that is caused by rough placement, solder-lack defect that is caused by manually pasting of the solder, or offset defect that is caused by floating of the multi-row QFN packaged chip during the rework process.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A pre-solder method for a multi-row quad flat no-lead (QFN) packaged chip, comprising:
applying solder paste on at least one pad of the multi-row QFN packaged chip; and
heating the multi-row QFN packaged chip, such that the solder paste on the at least one pad of the multi-row QFN packaged chip becomes solid solder before the multi-row QFN packaged chip is mounted on a substrate.

2. The pre-solder method as claimed in claim 1, further comprising:
de-absorbing the multi-row QFN packaged chip; and
cleaning the multi-row QFN packaged chip to remove residue on the at least one pad of the multi-row QFN packaged chip before applying the solder paste on the at least one pad of the multi-row QFN packaged chip.

3. The pre-solder method as claimed in claim 1, further comprising:
mounting the multi-row QFN packaged chip with the solid solder on the substrate.

4. The pre-solder method as claimed in claim 3, wherein the multi-row QFN packaged chip is mounted on pads of the substrate by heating the multi-row QFN packaged chip.

5. The pre-solder method as claimed in claim 1, wherein the step of applying the solder paste on the at least one pad of the multi-row QFN packaged chip further comprises:
placing the multi-row QFN packaged chip in a carrier; and
applying the solder paste on the at least one pad of the multi-row QFN packaged chip by a screen printer.

6. The pre-solder method as claimed in claim 5, wherein the step of heating the multi-row QFN packaged chip further comprises:
heating both the multi-row QFN packaged chip and the carrier in a reflow oven with a predetermined temperature, wherein the predetermined temperature is higher than a normal soldering temperature.

7. The pre-solder method as claimed in claim 1, the step of applying the solder paste on the at least one pad of the multi-row QFN packaged chip further comprises:
placing the multi-row QFN packaged chip in a jig;
covering the multi-row QFN packaged chip with a stencil; and
applying the solder paste on the at least one pad of the multi-row QFN packaged chip via the stencil.

8. The pre-solder method as claimed in claim 7, wherein the step of heating the multi-row QFN packaged chip further comprises:
removing the multi-row QFN packaged chip from the jig; and
baking the multi-row QFN packaged chip.

9. A rework method for mounting a multi-row quad flat no-lead (QFN) packaged chip on a substrate, comprising:
preparing a pre-soldered multi-row QFN packaged chip by applying solder paste on at least one pad of the multi-row QFN packaged chip which is to be mounted on the substrate and heating the applied solder paste on the multi-row QFN packaged chip to form solid solder;
placing the pre-soldered multi-row QFN packaged chip on the substrate, such that the at least one pad of the pre-soldered multi-row QFN packaged chip contacts at least one pad of the substrate via the solid solder on the pre-soldered multi-row QFN packaged chip; and
heating the placed pre-soldered multi-row QFN packaged chip to mount the placed pre-soldered multi-row QFN packaged chip on the substrate.

10. The rework method as claimed in claim 9, before the step of preparing a pre-soldered multi-row QFN packaged chip, further comprising:
pasting flux on the multi-row QFN packaged chip and heating the multi-row QFN packaged chip; and
removing the multi-row QFN packaged chip from the substrate.

11. The rework method as claimed in claim 9, further comprising:
pasting flux on the at least one pad of the substrate before placing the pre-soldered multi-row QFN packaged chip on the substrate.

12. The rework method as claimed in claim 9, before the step of placing the pre-soldered multi-row QFN packaged chip on the substrate, further comprising cleaning the at least one pad of the substrate to remove residue.

13. The rework method as claimed in claim 9, wherein the solder paste applied on the at least one pad of the pre-soldered multi-row QFN packaged chip becomes solid solder.

14. The rework method as claimed in claim 9, wherein the step of preparing the pre-soldered multi-row QFN packaged chip further comprises:
applying the solder paste on the at least one pad of the multi-row QFN packaged chip; and
heating the multi-row QFN packaged chip, such that the solder paste on the at least one pad of the multi-row QFN packaged chip becomes solid solder.

15. The rework method as claimed in claim 14, wherein the step of preparing the pre-soldered multi-row QFN packaged chip further comprises:
de-absorbing the multi-row QFN packaged chip; and
cleaning the multi-row QFN packaged chip to remove residue on the at least one pad of the multi-row QFN packaged chip before applying the solder paste on the at least one pad of the multi-row QFN packaged chip.

16. The rework method as claimed in claim 14, wherein the step of applying the solder paste on the at least one pad of the multi-row QFN packaged chip further comprises:
placing the multi-row QFN packaged chip in a carrier; and
applying the solder paste on the at least one pad of the multi-row QFN packaged chip by a screen printer.

17. The rework method as claimed in claim 16, wherein the step of heating the multi-row QFN packaged chip further comprises:
heating both the multi-row QFN packaged chip and the carrier in a reflow oven with a predetermined temperature, wherein the predetermined temperature is higher than a normal soldering temperature.

18. The rework method as claimed in claim 14, the step of applying the solder paste on the at least one pad of the multi-row QFN packaged chip further comprises:
placing the multi-row QFN packaged chip in a jig;
covering the multi-row QFN packaged chip with a stencil; and
applying the solder paste on the at least one pad of the multi-row QFN packaged chip via the stencil.

19. The rework method as claimed in claim 18, wherein the step of heating the multi-row QFN packaged chip further comprises:
removing the multi-row QFN packaged chip from the jig; and
baking the multi-row QFN packaged chip.

20. The rework method as claimed in claim 10, further comprising:
heating the substrate to a predetermined temperature before removing the multi-row QFN packaged chip.
